(19) United States
(12) Patent Application Publication
(10) Pub. No.: US 2012/0207605 A1
(43) Pub. Date: Aug. 16, 2012

(54) BLADE ASSEMBLY FOR A WIND TURBINE

(75) Inventor: Azad Hessamodini, Shenton Park (AU)

(73) Assignee: WINDWORKS ENGINEERING LIMITED, Limassol (CY)

(21) Appl. No.: 13/391,152

(22) PCT Filed: Aug. 20, 2010
(86) PCT No.: PCT/AU10/01079

§ 371 Date: May 3, 2012

(30) Foreign Application Priority Data
Aug. 20, 2009 (AU) 2009903946
Aug. 20, 2009 (AU) 2009903950

(51) Int. Cl. F03D 3/06

(52) U.S. Cl. 416/196 A; 416/223 R

(57) ABSTRACT

A blade assembly is for a wind turbine, such as a vertical axis wind turbine. The blade assembly includes 3 or more blades and has an axis of rotation about which in use the blades rotate. In one variation the blades are elongated and have first and second ends and are twisted between their ends. The blades are positioned along the axis of rotation in a manner such that the first (bottom) end of each blade has a portion that has substantially the same angular orientation as a portion of the second (top) end of an adjacent blade. Alternatively or additionally the blades are arranged for orientation along the axis of rotation and are twisted about an axis of twist. The axis of twist substantially coincides with the axis of rotation of the wind turbine.

### FIELD OF THE INVENTION

The present invention broadly relates to a blade assembly for a wind turbine. Particularly, although not exclusively, the present invention relates to a blade assembly for a vertical axis wind turbine.

### BACKGROUND OF THE INVENTION

Vertical axis wind turbines, which have a rotatable blade assembly arranged in a substantially vertical direction, are not dependent on wind direction like their horizontal axis wind turbine counterparts. Vertical axis wind turbines come in a variety of forms, including Darrieus or so called ‘eggbeater’ wind turbines and Savonius wind turbines. Another type of vertical axis wind turbine is described in PCT international publication no. WO 03/058061 entitled “A Vertical Axis Turbine”.

There is now great interest in using vertical axis wind turbines to harness renewable energy.

### SUMMARY OF THE INVENTION

The present invention provides in a first aspect a blade assembly for a wind turbine, the blade assembly comprising 3 or more blades and having an axis of rotation about which in use the blades rotate, the blade assembly having first and second ends, the blades being elongated and having first and second ends that are located at the first and second ends of the blade assembly, respectively, the blades being twisted between their first and second ends and positioned along the axis of rotation in a manner such that the first end of each blade has a portion that has substantially the same angular orientation as a portion of the second end of an adjacent blade.

The blade assembly may be arranged so that in use an axis of the twist is substantially parallel the axis of rotation of the wind turbine and may also coincide with the axis of rotation.

The present invention provides in a second aspect a blade assembly for a wind turbine, the blade assembly comprising blades and the wind turbine having an axis of rotation about which in use the blades rotate, the blades being arranged for orientation along the axis of rotation and being twisted about an axis of twist, wherein the axis of twist substantially coincides with the axis of rotation of the wind turbine.

The blade assembly typically has first and second ends and the blades typically are elongated and having first and second ends that are located at the first and second ends of the blade assembly, respectively. Each blade may be twisted in a manner such that a portion of the first end of each blade has substantially the same angular orientation as a portion of the second end of an adjacent blade.

The following description relates to features that the blade assembly in accordance with either the first or the second aspect of the present invention may have.

The axis of rotation of the blade assembly typically is a substantially vertical axis.

Each blade of the blade assembly typically is a substantially rectangular element that is twisted. The first end second ends of each blade typically are end edges of the substantially rectangular element.

In one specific embodiment the blade assembly comprises 3 blades and each blade is twisted in a manner such that corresponding portions of the first and second ends of each blade have an angular orientation that differs by substantially 120°.

In another example the blade assembly comprises 4 blades and each blade is twisted in a manner such that corresponding portions of the first and second ends of each blade have an angular orientation that differs by substantially 90°.

Each blade typically has an inner blade portion and an outer blade portion, the inner blade portion being closer to the axis of rotation than the outer blade portion. The inner blade portions and the outer blade portions may be twisted differently. The inner blade portions may be twisted such that, at the inner blade portions, the first end of each blade has substantially the same angular orientation as the second end of an adjacent blade and the outer blade portions may be twisted more or less than the inner blade portions.

Alternatively, the first and second ends of the blades may be twisted in a manner such that the entire first end of each blade has substantially the same angular orientation as the entire second end of an adjacent blade.

Each blade may have any suitable length, for example 3-5 m, 5-10 m or even longer. Further, each blade may have any suitable width, such as 1-1.5 m, or 1.5-3 m or more.

The length to width aspect ratio of each blade may be any suitable ratio such as 1:1-3:1, or 1.5:1-2.5:1 or 1.6:1-2.2:1. In one specific example the aspect ratio is 1.61:1.

In one example the blades of the blade assembly are distributed at 120° around the axis of rotation of the turbine. In this example the blades typically are twisted by substantially 120°.

In other variations the first and second ends of the blades may have angular orientations that differ in angular orientation by another suitable angle that typically is in the range of 90°-150° such as substantially 90°, 100°, 110°, 130°, 140° or 150°.

The blade assembly may comprise a central mast and coupling members that couple the blades to the mast and to each other. At least one coupling member may couple the blades to each other without coupling the blades to the mast and at least one other coupling member may couple the blades to each other and to the mast.

The present invention provides in a third aspect a wind turbine having the blade assembly in accordance with the first or second aspect of the present invention.

The invention will be more fully understood from the following description of specific embodiments of the invention. The description is provided with reference to the accompanying drawings.

### BRIEF DESCRIPTION OF THE DRAWINGS

FIG. 1 shows a perspective view of a blade for a wind turbine in accordance with an embodiment of the present invention;

FIG. 2a shows a cross-sectional view of a lower section of the blade of FIG. 1;

FIG. 2b shows a cross sectional view of an upper section of the blade of FIG. 1;

FIG. 3 shows a series of cross-sectional views of the blade assembly of FIG. 1; and

FIG. 4a shows a series of cross-sectional representations of a blade assembly according to an embodiment of the present invention;

FIG. 4b shows a schematic diagram indicating locations of cross-sections shown in FIG. 4a;

FIG. 5 shows a perspective view of a wind turbine in accordance with a further embodiment of the present invention.

### DETAILED DESCRIPTION OF SPECIFIC EMBODIMENTS

Embodiments of the present invention relate to a blade assembly for a wind turbine, such as a vertical axis wind turbine. The blade assembly comprises 3 or more blades and has an axis of rotation about which in use the blades rotate.

The blades are elongated and have first and second ends and are twisted between their ends. The blades are positioned along the axis of rotation. In one variation the blades are arranged in a manner such that the first (bottom) end of each blade has a portion that has substantially the same angular orientation as a portion of the second (top) end of an adjacent blade. Alternatively or additionally, the blades are arranged such that the axis of twist substantially coincides with the axis of rotation of the wind turbine.

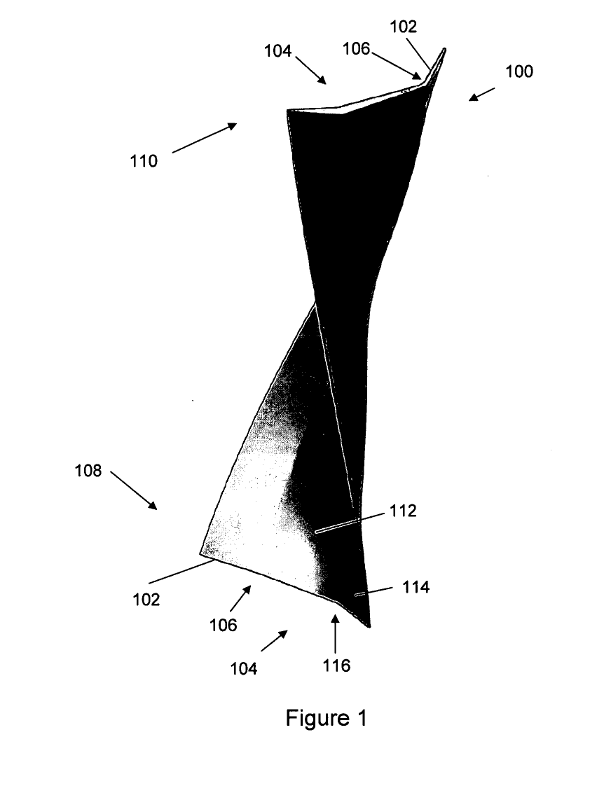

Referring initially to FIGS. 1-3, there is shown a blade 100 comprising an outer blade portion 102 and an inner blade portion 104. An angle 106 between the outer and inner blade portions 102, 104 is shown to vary from a first end 108 to a second end 110 of the blade 100.

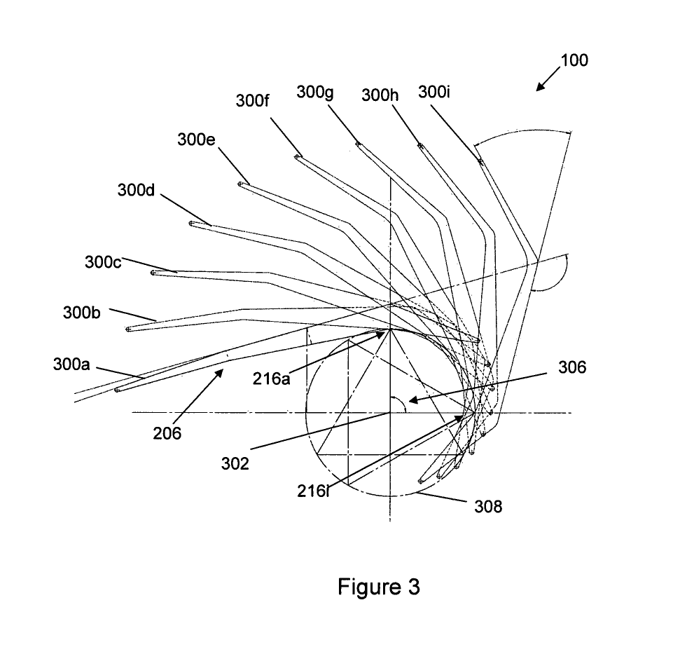

FIG. 1 also shows the blade 100 twisting in a helical fashion about an axis 302 (shown in FIG. 3) located outside the blade 100. In this example, the inner blade portion 104 is twisted through substantially 120°. It will be understood that the twist may be any suitable twist, such as 90° or 180°. It will also be appreciated that other configurations are envisaged, for example configurations in which the outer blade portion 102 has a twist that is larger than the inner blade portion 104.

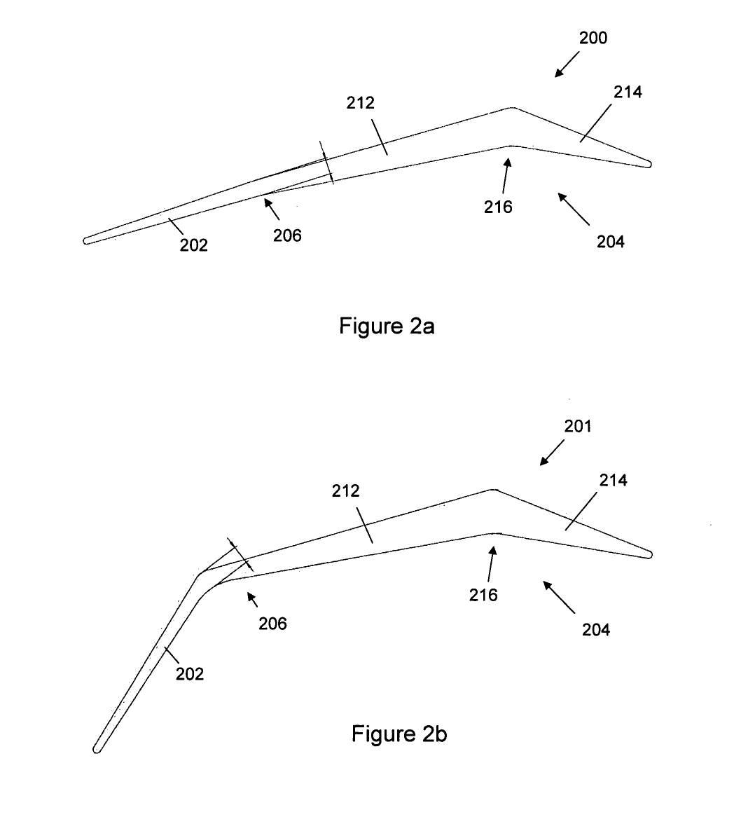

FIG. 2a shows a cross-sectional view 200 taken from the first end 108 of the blade 100. In this specific example, an angle of 206 between an outer blade portion 202 and an inner blade portion 204 is 177°. In other words, an angle of tip of the outer blade portion is 3°.

FIG. 2b shows a cross-sectional view 201 taken from the second end 110 of the blade 100. In this example, the angle 206 between the outer and inner blade portions 202, 204 is 137°. In other words, the angle of tip of the outer blade portion 202 is 43° in this example.

It will be appreciated that the angle 206 between the outer and inner blade portions 202, 204 may be any appropriate angle and may vary in any suitable manner along the length of the blade 100. Further, the inner and outer blade portions may be twisted in the same manner and the angle 206 may be 180°.

The twist of blade 100 and the changing angle 206 between the outer and inner blade portions 202, 204 are indicated in FIG. 3, which shows a series of cross-sections 300a to 300i taken at uniform sections along the length of blade 100. In this example, cross-section 300a corresponds to the cross-section taken at the first end 108 of blade 100.

FIG. 3 shows the blade 100 twisting around axis 302, which coincides with the axis of rotation of the turbine. The twist causes the blade 100 to move through an angle 304 of 120°. It will be appreciated that this is only one example of a possible twist, and other twist angles and orientations are envisaged.

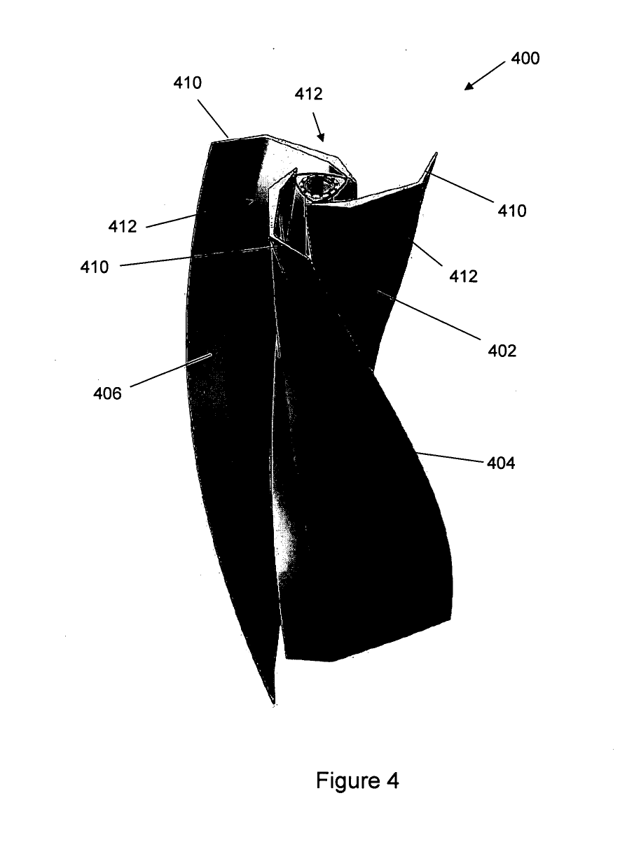

FIG. 4 shows representations of blades of a wind turbine in accordance with an embodiment of the present invention. FIG. 4 (a) shows cross-sectional representations at sections 1-9, which are indicated in FIG. 4 (b). As can be seen by comparing the cross-sections taken at sections 1 and 9, bottom ends of inner blade portions have the same angular orientation as top ends of inner portions of adjacent blades.

Referring now to FIG. 5 there is shown a blade assembly 500 comprising a plurality of blades 502, 504 and 506 mounted at 120° intervals around a mast 508. An inner blade portion 512 of each blade 502, 504, 506 is mounted to the mast 508 and an outer blade portion 510 is a free end. The wind turbine comprises coupling members 514 that couple the blades to each other and to the mast 508. In this embodiment the mast 508 extends to a top portion of the wind turbine 500. Alternatively, the mast may be shorter. In this case for example a bottom coupling member may couple the blades to each other and to the mast, while the other coupling members couple the blades to each other, but not to the mast. The axis of rotation of the wind turbine and the axis of twist of the blades coincide with each other and are positioned within the mast 508. The wind turbine 500 also comprises a generator, which is not shown.

In the example shown in FIG. 5 the blades have top and bottom ends that have, at the inner blade portions, the same angular orientation as bottom and top ends of adjacent blades, respectively. In a variation of this embodiment the blades may have entire top and bottom ends that have the same angular orientation as bottom and top ends of adjacent blades, respectively.

The blades of the wind turbine are approximately 5.5 m long and 1.8 m wide. In other variations the blades may have any other suitable length or width, such as 3-5 m, 5-10 m or even longer. Further, each blade may have any suitable width, such as 1-1.5 m, or 1.5-3 m or more.

In this specific example the aspect ratio is 1.61:1, but alternatively may be any other suitable ratio.

The blades may for example be formed from fibreglass or a molded plastics material. Alternatively, the blades may be formed from a metallic material.

Although the invention has been described with reference to particular examples, it will be appreciated by those skilled in the art that the invention may be embodied in many other forms. For example, a wind turbine comprising the blades may comprise any number of blades arranged in any suitable fashion. Similarly, it is envisaged that the amount of twist may be different for different configurations.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention. Reference that is being made to PCT international publication no. WO 03/058061 does not constitute an admission that that publication is part of the common general knowledge of a skilled person in Australia or any other country.

1. A blade assembly for a wind turbine, the blade assembly comprising 3 or more blades and having an axis of rotation about which in use the blades rotate, the blade assembly having first and second ends, the blades being elongated and having first and second ends that are located at the first and second ends of the blade assembly, respectively, the blades being twisted between their first and second ends and positioned along the axis of rotation in a manner such that the first end of each blade has a portion that has substantially the same angular orientation as a portion of the second end of an adjacent blade.

2. The blade assembly of claim 1 wherein the blade assembly is arranged so that in use an axis of the twist substantially coincides with the axis of rotation.

3. A blade assembly for a wind turbine, the blade assembly comprising blades and the wind turbine having an axis of rotation about which in use the blades rotate, the blades being arranged for orientation along the axis of rotation and being twisted about an axis of twist, wherein the axis of twist substantially coincides with the axis of rotation of the wind turbine.

4. The blade assembly of claim 3 wherein the blade assembly has first and second ends, the blades being elongated and having first and second ends that are located at the first and second ends of the blade assembly, respectively, wherein the blades are twisted in a manner such that a portion of the first end of each blade has substantially the same angular orientation as a portion of the second end of an adjacent blade.

5. The blade assembly of claim 1 wherein the axis of rotation of the blade is a substantially vertical axis.

6. The blade assembly of claim 1 wherein each blade of the blade assembly is a substantially rectangular element that is twisted.

7. The blade assembly of claim 6 wherein the first end second ends of each blade are end edges of the substantially rectangular element.

8. The blade assembly of claim 1 comprising 3 blades and each blade is twisted in a manner such that corresponding portions of the first and second ends of each blade have an angular orientation that differs by substantially 120°.

9. The blade assembly of claim 1 wherein each blade has an inner blade portion and an outer blade portion, the inner blade portions being closer to the axis of rotation than the outer blade portions and the inner blade portions and the outer blade portions being twisted differently.

10. The blade assembly of claim 1 wherein the first and second ends of the blades are twisted in a manner such that the entire first end of each blade has substantially the same angular orientation as the entire second end of an adjacent blade.

11. The blade assembly of claim 1 wherein each blade has a length of 3-5 m.

12. The blade assembly of claim 1 wherein each blade has a length of 5-10 m.

13. The blade assembly of claim 1 wherein each blade has a length of 1-1.5 m.

14. The blade assembly of claim 1 wherein the length to width aspect ratio of each blade is 1:1-3:1.

15. The blade assembly of claim 1 wherein the blades of the blade assembly are distributed at 120° around the axis of rotation of the wind turbine.

16. The blade assembly of claim 15 wherein the blades are twisted by substantially 120°.

17. The blade assembly of claim 1 comprising a central mast and coupling members that couple the blades to the mast and to each other.

18. The blade assembly of claim 17 wherein at least one coupling member couples the blades to each other without coupling the blades to the mast and at least one other coupling member may couple the blades to each other and to the mast.

19. A wind turbine having the blade assembly of claim 1.

20. A wind turbine having the blade assembly of claim 3.
